(19) United States
(12) Patent Application Publication
(10) Pub. No.: US 2022/0269130 A1
(43) Pub. Date: Aug. 25, 2022

(54) BACKLIGHT MODULE AND DISPLAY APPARATUS

(71) Applicant: Coretronic Corporation, Hsin-Chu (TW)

(72) Inventors: Cheng-Hsien Chou, Hsin-Chu (TW); Chen-Hung Lin, Hsin-Chu (TW); Yu-Yu Liu, Hsin-Chu (TW)

(73) Assignee: Coretronic Corporation, Hsin-Chu (TW)

(21) Appl. No.: 17/584,406

(22) Filed: Jan. 26, 2022

(30) Foreign Application Priority Data
Feb. 25, 2021 (CN) 202120415182.4

(51) Int. Cl. G02F 1/13357; F21V 8/00

(52) U.S. Cl. CPC G02F 1/133603; G02F 1/133606; G02B 6/0051

(57) ABSTRACT

A backlight module including a substrate, light-emitting elements, an optical element, first microstructures, and second microstructures is provided. The light-emitting elements are disposed on the substrate. The light-emitting elements are located between the optical element and the substrate. The first microstructures are located between the optical element and the light-emitting elements and respectively shield the light-emitting elements. The optical element is located between the second microstructures and the first microstructures. An area of each of the first microstructures is greater than an area of each of the second microstructures. Moreover, a display apparatus including the backlight module is also provided.

### CROSS-REFERENCE TO RELATED APPLICATION

This application claims the priority benefit of Chinese application no. 202120415182.4, filed on Feb. 25, 2021. The entirety of the above-mentioned patent application is hereby incorporated by reference herein and made a part of this specification.

### BACKGROUND

### Technical Field

The disclosure relates to a light source module and a display apparatus, and particularly relates to a backlight module and a display apparatus including the backlight module.

### Description of Related Art

Compared to a conventional light-emitting diode, a mini-light-emitting diode (mini-LED) is small in size, but not to the extent to be directly used as pixels in terms of applications to displays (e.g., television). However, the mini-LED may be applied in a backlight module to realize an improved backlight module. For example, the mini-LED, together with a flexible substrate, may realize a backlight module having a curved surface. The mini-LED, together with screen properties of a display panel adopting a local light adjustment design, may enable a display apparatus to have better color rendering and to also have power saving functions.

At present, the backlight module is designed to be increasingly thin and light, causing a light-mixing distance between the mini-LED and other components of the backlight module to be increasingly reduced, or even approach zero. With the limited light-mixing distance of the backlight module, an illumination light beam emitted toward the right above of the mini-LED cannot be effectively diffused for a bright region to be formed right above the mini-LED. In the meantime, a dark region is formed between multiple mini-LEDs. On the whole, the backlight module may then generate light shades exhibiting interleaving brightness and darkness, adversely affecting the optical performance of the backlight module and the display quality of the display apparatus.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention were acknowledged by a person of ordinary skill in the art.

### SUMMARY

The disclosure provides a backlight module, which is capable of blurring light shades and has good optical performance.

The disclosure provides a display apparatus, which applies the above-mentioned backlight module and has good display quality.

Other purposes and advantages of the disclosure may be further understood from the technical features disclosed herein.

To achieve one, some, or all of the above-mentioned purposes or other purposes, a backlight module according to an embodiment of the disclosure includes a substrate, a plurality of light-emitting elements, an optical element, a plurality of first microstructures, and a plurality of second microstructures. The light-emitting elements are disposed on the substrate. Each of the light-emitting elements is adapted to provide an illumination light beam. The light-emitting elements are located between the optical element and the substrate. The first microstructures are located between the optical element and the light-emitting elements and respectively shield the light-emitting elements. The optical element is located between the second microstructures and the first microstructures. An area of each of the first microstructures is greater than an area of each of the second microstructures.

To achieve one, some, or all of the above-mentioned purposes or other purposes, a display apparatus according to an embodiment of the disclosure includes the above-mentioned backlight module and a display panel disposed on the backlight module.

Based on the foregoing, through the first microstructures, the proportion of the illumination light beam emitted by the light-emitting element that directly penetrates out of the backlight module can be reduced. Through the second microstructures, the number of times that the illumination light beam emitted by the light-emitting element is refracted/diffused by the internal structure of the optical element can be increased. Accordingly, the illumination light beam can be uniformly diffused within a limited distance to the first regions above the light-emitting element and the second region between the first regions, achieving blurring of light shades of the backlight module. The display apparatus of the disclosure embodiment applies the backlight module and has good display quality.

Other objectives, features and advantages of the invention will be further understood from the further technological features disclosed by the embodiments of the invention wherein there are shown and described preferred embodiments of this invention, simply by way of illustration of modes best suited to carry out the invention.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a display apparatus 10 according to an embodiment of the disclosure.

FIG. 2 is a schematic cross-sectional view of a display apparatus 10A according to an embodiment of the disclosure.

FIG. 3 is a schematic cross-sectional view of a display apparatus 10B according to an embodiment of the disclosure.

FIG. 4 is a schematic cross-sectional view of a display apparatus 10C according to an embodiment of the disclosure.

FIG. 5 is a schematic cross-sectional view of a display apparatus 10D according to an embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

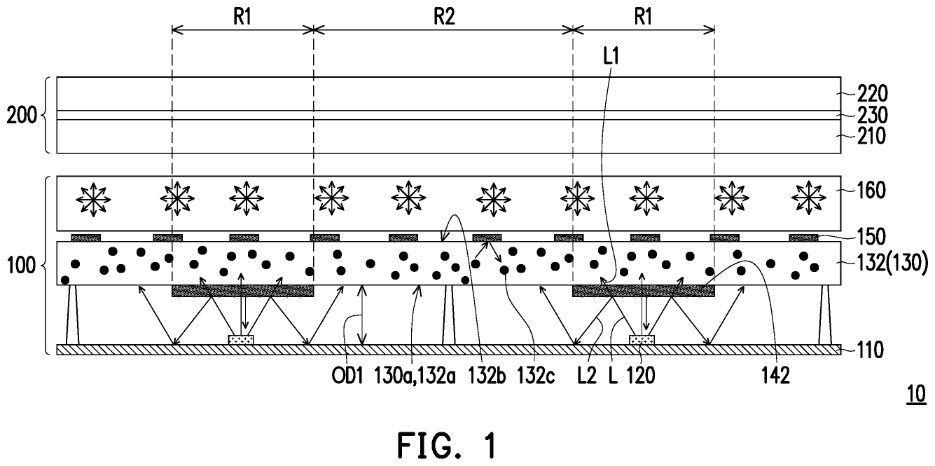

FIG. 1 is a schematic cross-sectional view of a display apparatus 10 according to an embodiment of the disclosure. With reference to FIG. 1, the display apparatus 10 includes a backlight module 100 and a display panel 200. The display panel 200 is disposed on the backlight module 100. The display panel 200 may include, for example, a pixel array substrate 210, an opposite substrate 220, and a non-self-luminous display medium 230. The pixel array substrate 210 is disposed opposite to the opposite substrate 220. The non-self-luminous display medium 230 is disposed between the pixel array substrate 210 and the opposite substrate 220. For example, in this embodiment, the non-self-luminous display medium 230 is liquid crystals, but not limited thereto.

The backlight module 100 includes a substrate 110 and a plurality of light-emitting elements 120 disposed on the substrate 110. Each of the light-emitting elements 120 is adapted to provide an illumination light beam L. For example, in this embodiment, the substrate 110 is a circuit board provided with the light-emitting element 120, but the disclosure is not limited thereto. In this embodiment, the light-emitting element 120 is, for example, a mini-LED, but the disclosure is not limited thereto. In other embodiments, the light-emitting element 120 may also be of other sizes and/or forms. In this embodiment, the light-emitting element 120 is, for example, adapted to emit the illumination light beam L of blue color. Nonetheless, the disclosure is not limited thereto. In other embodiments, the light-emitting element 120 may also be adapted to emit the illumination light beam L of other colors, such as but not limited to white light.

The backlight module 100 further includes an optical element 130, a plurality of first microstructures 142, and a plurality of second microstructures 150. The light-emitting elements 120 are located between the optical element 130 and the substrate 110. The first microstructures 142 are located between the optical element 130 and the light-emitting elements 120 and respectively shield the light-emitting elements 120. The optical element 130 is located between the second microstructures 150 and the first microstructures 142, and an area of each first microstructure 142 is greater than an area of each second microstructure 150.

The optical element 130 has a light incident surface 130a facing the light-emitting elements 120. The light incident surface 130a of the optical element 130 is spaced apart from the substrate 110 by a distance OD1. The distance OD1 is namely a light-mixing distance of the backlight module 100. In this embodiment, OD1<5 mm. In other words, the light-mixing distance of the backlight module 100 is relatively reduced.

For example, in this embodiment, the optical element 130 may include a diffuser plate 132, which has an light incident surface 132a (i.e., the light incident surface 130a) and a light emitting surface 132b opposite to each other. The first microstructures 142 and the second microstructures 150 may be respectively disposed on the light incident surface 132a and the light emitting surface 132b of the diffuser plate 132. Nonetheless, the disclosure is not limited thereto. In other embodiments, the first microstructures 142 and/or the second microstructures 150 may also be disposed on other components of the backlight module, examples of which in conjunction with other drawings will be provided in the following paragraphs.

For example, in this embodiment, the first microstructure 142 may be a large printed dot, and the second microstructure 150 may be a small printed dot. In this embodiment, the area of each first microstructure 142 may completely shield the halo emitted by the corresponding light-emitting element 120. The area of each second microstructure 150 is less than the area of each first microstructure 142. In other words, the ratio of the area of one second microstructure 150 to the area of one first microstructure 142 is less than one. The actual value of the ratio of the area of the second microstructure 150 to the area of the first microstructure 142 may be determined depending on the overall optical effect to be achieved by the backlight module 100, and the spacing between the second microstructures 150 may also be determined depending on the overall optical effect to be achieved by the backlight module 100, which are not limited by the disclosure.

In this embodiment, part of the second microstructures 150 are overlapped with the first microstructures 142. In other words, the second microstructures 150 are disposed not only in a plurality of first regions R1 above the first microstructures 142, but the second microstructures 150 are also disposed in second regions R2 between the first regions R1.

In this embodiment, a configuration density of the second microstructures 150 may be greater than a configuration density of the first microstructures 142. In this embodiment, the second microstructures 150 may selectively be evenly distributed. Nonetheless, the disclosure is not limited thereto. The distribution of the second microstructures 150 may vary depending on the overall optical effect to be achieved by the backlight module 100.

The backlight module 100 further includes at least one optical film 160. The second microstructures 150 are disposed between the at least one optical film 160 and the optical element 130. For example, in this embodiment, the at least one optical film 160 may include a color conversion film, which is adapted for color conversion and adjustment on the illumination light beam L emitted by the light-emitting element 120. For example, when the illumination light beam L emitted by the light-emitting element 120 is blue light, part of which is converted into red light and green light after passing through the color conversion film, and another part of which is not converted after passing through the color conversion film. After the two parts of blue light are mixed, white light is formed. The above is only an embodiment of the disclosure, and is not intended to limit the disclosure. The material of the color conversion film may include quantum dot (QD), KSF+β-Sialon, YAG, etc., but the disclosure is not limited thereto. In another embodiment, when the illumination light beam L emitted by the light-emitting element 120 is white light, it is also possible that the at least one optical film 160 does not include the color conversion film, and other types of optical film may be adopted instead. For example, the at least one optical film 160 may also include a brightness enhancement film, a prism sheet, or a combination thereof, to adjust the optical effect of the illumination light beam L.

It is worth mentioning that, by shielding the first microstructures 142 of the light-emitting element 120, the proportion of the illumination light beam L emitted by the light-emitting element 120 that directly penetrates out of the backlight module 100 can be reduced. Through the second microstructures 150, the number of times that the illumination light beam L emitted by the light-emitting element 120 is refracted/diffused by the internal structure of the optical element 130 (for example but not limited to, diffusion particles 132c of the diffuser plate 132) can be increased. Accordingly, the illumination light beam L can be uniformly diffused to the first regions R1 above the light-emitting elements 120 and the second region R2 between the first regions R1, achieving blurring of light shades of the backlight module 100 and screen optimization of the display apparatus 10.

To be specific, in this embodiment, the illumination light beam L emitted by the light-emitting element 120 includes a first portion L1 that penetrates the first microstructure 142 and a second portion L2 that is reflected by the first microstructure 142. The first portion L1 of the illumination light beam L sequentially penetrates the first microstructure 142, is refracted/diffused at least once by the internal structure of the optical element 130, and then is emitted after being diffused in the first region R1 above the light-emitting element 120. The second portion L2 of the illumination light beam L is sequentially reflected by the first microstructure 142, is reflected by the substrate 110, is refracted/diffused at least once by the internal structure of the optical element 130, and then is emitted after being diffused in the second region R2. Through the second microstructures 150, the number of times that the first portion L1 and/or the second portion L2 of the illumination light beam L is refracted/diffused by the internal structure of the optical element 130 can be increased, so as to improve blurring of light shades of the backlight module 100 and screen optimization of the display apparatus 10.

It should be noted here that the reference numerals and partial contents in the above embodiment remain to be used in the following embodiments, where the same reference numerals are used to refer to the same or similar elements, and the description of the same technical content is omitted. Reference may be made to the above embodiment for the description of the omitted part, which will not be repeated in the following embodiments.

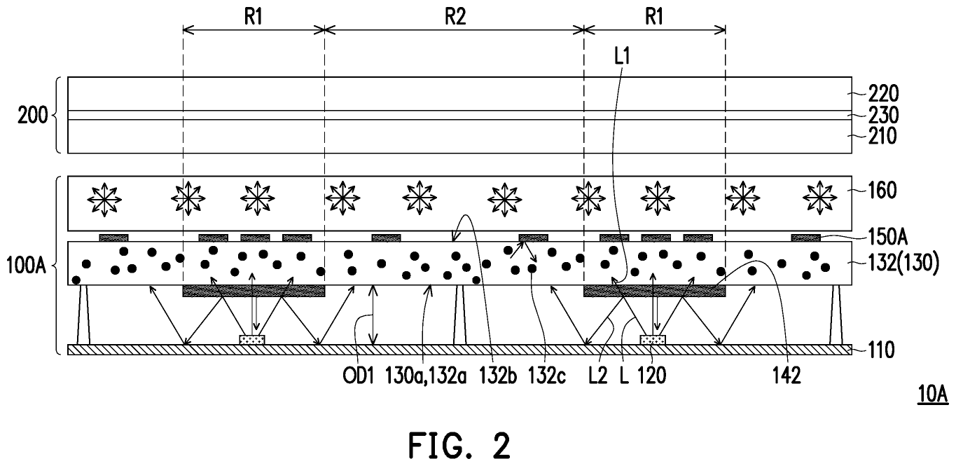

FIG. 2 is a schematic cross-sectional view of a display apparatus 10A according to an embodiment of the disclosure. The display apparatus 10A and a backlight module 100A thereof in FIG. 2 are similar to the display apparatus 10 and the backlight module 100 thereof in FIG. 1, and the difference between them lies in that the distribution of a plurality of second microstructures 150A in FIG. 2 is different from the distribution of the second microstructures 150 in FIG. 1.

With reference to FIG. 2, in this embodiment, the second microstructures 150A may be unevenly distributed. Specifically, in this embodiment, a configuration density of the second microstructures 150A gradually decreases from a place close to the first microstructures 142 to a place away from the first microstructures 142. In other words, the second microstructures 150A are disposed more densely at a place close to the light-emitting elements 120, and the second microstructures 150A are disposed more sparsely at a place away from the light-emitting elements 120. Such configuration helps the first portion L1 of the illumination light beam L emitted by the light-emitting elements 120 that penetrates the first microstructure 142 to be more uniformly diffused, so as to improve blurring of light shades of the backlight module 100 and display screen optimization of the display apparatus 10.

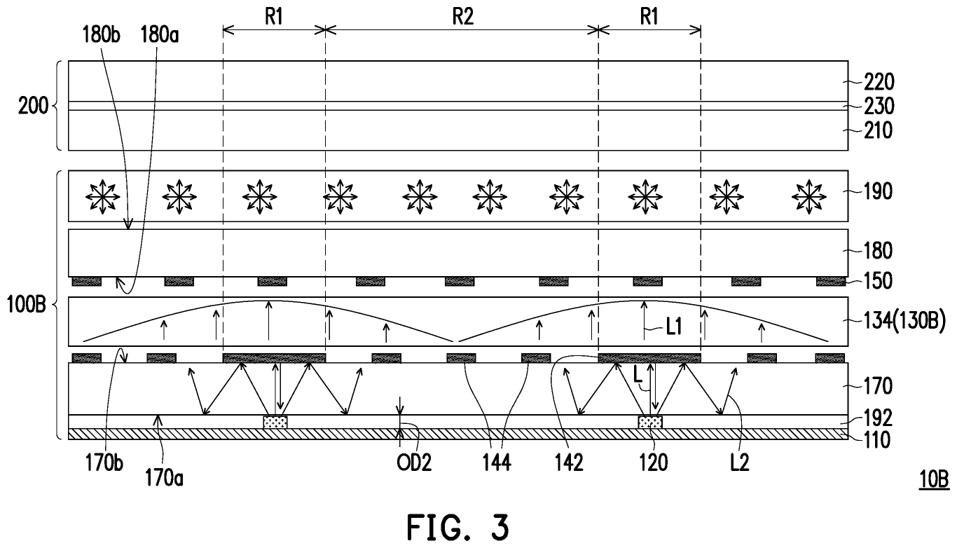

FIG. 3 is a schematic cross-sectional view of a display apparatus 10B according to an embodiment of the disclosure. The display apparatus 10B and a backlight module 100B thereof in FIG. 3 are similar to the display apparatus 10 and the backlight module 100 thereof in FIG. 1, and the difference between them lies in that an optical element 130B in FIG. 3 is different from the optical element 130 in FIG. 1. In addition, the display apparatus 10B and the backlight module 100B thereof in FIG. 3 also include a lower diffuser plate 170, an upper diffuser plate 180, and a plurality of third microstructures 144.

With reference to FIG. 3, in this embodiment, the optical element 130B includes at least one first optical film 134. For example, in this embodiment, the at least one first optical film 134 of the optical element 130B may include a partial wavelength transmissive and partial wavelength reflective film (not shown) and a color conversion film (not shown). For example, when the illumination light beam L emitted by the light-emitting element 120 is blue light, part of which sequentially passes through the partial wavelength transmissive and partial wavelength reflective film and is converted into red light and green light after passing through the color conversion film, and another part of which is not converted after passing through the partial wavelength transmissive and partial wavelength reflective film and the color conversion film. After the two parts of blue light are mixed, white light is formed. The above is only an embodiment of the disclosure, and is not intended to limit the disclosure. The material of the color conversion film may include quantum dot (QD), KSF+β-Sialon, YAG, etc., but not limited thereto. In another embodiment, when the illumination light beam L emitted by the light-emitting element 120 is white light, it is possible that the optical element 130B does not include the color conversion film and the partial wavelength transmissive and partial wavelength reflective film, and other types of optical film may be adopted instead. For example, the at least one first optical film 134 of the optical element 130B may also include a brightness enhancement film, a prism sheet, or a combination thereof, to adjust the optical effect of the illumination light beam L.

In this embodiment, the backlight module 100B further includes the lower diffuser plate 170 and the upper diffuser plate 180. The lower diffuser plate 170 is disposed between the first microstructures 142 and the light-emitting elements 120. Specifically, in this embodiment, the backlight module 100B further includes a protective adhesive layer 192. The protective adhesive layer 192 is disposed on the substrate 110 and covers the light-emitting elements 120. The lower diffuser plate 170 may be disposed on the protective adhesive layer 192.

The lower diffuser plate 170 has a light incident surface 170a facing the light-emitting elements 120. The light incident surface 170a of the lower diffuser plate 170 is spaced apart from the substrate 110 by a distance OD2. The distance OD2 is namely a light-mixing distance of the backlight module 100B. For example, in this embodiment, 0.2 mm<OD2<0.3 mm. In other words, the light-mixing distance of the backlight module 100B approaches zero. In addition, since the protective adhesive layer 192 is disposed between the lower diffuser plate 170 and the substrate 110 to protect the light-emitting elements 120, the thickness of the protective adhesive layer 192 is substantially equal to the distance OD2.

In this embodiment, the backlight module 100B further includes the upper diffuser plate 180. The at least one first optical film 134 is disposed between the upper diffuser plate 180 and the lower diffuser plate 170. The lower diffuser plate 170 has the light incident surface 170a and a light emitting surface 170b opposite to each other. The first microstructures 142 are disposed on the light emitting surface 170b of the lower diffuser plate 170. The upper diffuser plate 180 has an light incident surface 180a and a light emitting surface 180b opposite to each other. The second microstructures 150 are disposed on the light incident surface 180a of the upper diffuser plate 180.

In this embodiment, the backlight module 100B further includes the third microstructures 144. The third microstructures 144 are disposed between the at least one first optical film 134 and the light-emitting elements 120, and are located beside the first microstructures 142. An area of each third microstructure 144 is less than the area of each first microstructure 142. Through the third microstructure 144, the number of times that the illumination light beam L is refracted/diffused by the internal structure of the at least one first optical film 134 can be increased, so as to improve blurring of light shades of the backlight module 100B and display screen optimization of the display apparatus 10B.

In this embodiment, the first microstructures 142 and the third microstructures 144 may both be disposed on the light emitting surface 170b of the lower diffuser plate 170. In this embodiment, the third microstructures 144 may selectively be evenly disposed between any two of the first microstructures 142, but the disclosure is not limited thereto.

In this embodiment, the backlight module 100B further includes at least one second optical film 190. The second microstructures 150 are disposed between the at least one second optical film 190 and the at least one first optical film 134. For example, in this embodiment, the at least one second optical film 190 may include a diffuser sheet, a brightness enhancement film, a prism sheet, or a combination thereof. Nonetheless, the disclosure is not limited thereto. The quantity and type of the at least one second optical film 190 may vary depending on the optical effect to be achieved by the backlight module 100B, which are not limited by the disclosure.

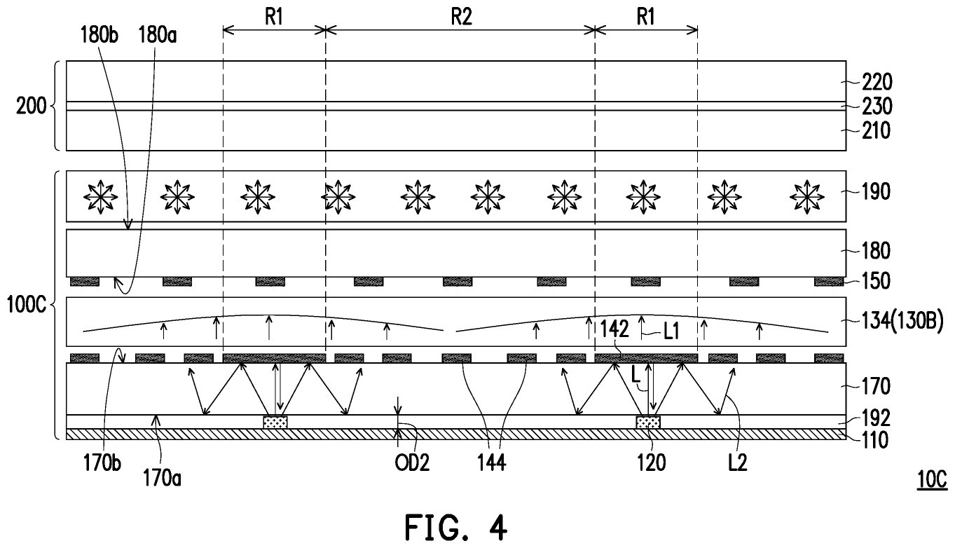

FIG. 4 is a schematic cross-sectional view of a display apparatus 10C according to an embodiment of the disclosure. The display apparatus 10C and a backlight module 100C thereof in FIG. 4 are similar to the display apparatus 10B and the backlight module 100B thereof in FIG. 3, and the difference between them lies in that the distribution of the third microstructures 144 in FIG. 4 is different from the distribution of the third microstructures 144 in FIG. 3.

In this embodiment, the third microstructures 144 may be unevenly disposed between any two of the first microstructures 142. Specifically, in this embodiment, a configuration density of the third microstructures 144 gradually decreases from a place close to the first microstructures 142 to a place away from the first microstructures 142. In other words, the third microstructures 144 are disposed more densely at a place close to the light-emitting elements 120, and the third microstructures 144 are disposed more sparsely at a place away from the light-emitting elements 120. Such configuration helps the first portion L1 of the illumination light beam L emitted by the light-emitting elements 120 that penetrates the first microstructure 142 to be more uniformly diffused, so as to improve blurring of light shades of the backlight module 100C and the screen optimization of the display apparatus 10C.

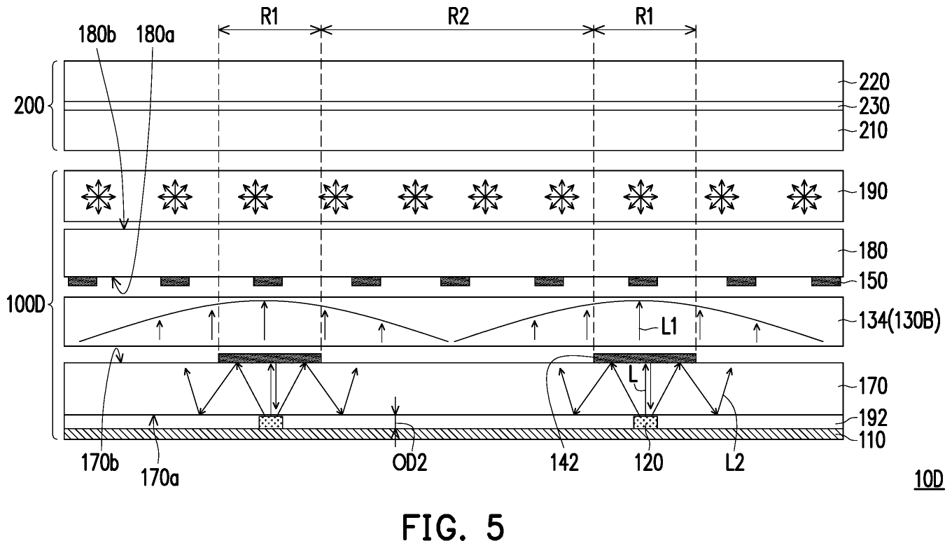

FIG. 5 is a schematic cross-sectional view of a display apparatus 10D according to an embodiment of the disclosure. The display apparatus 10D and a backlight module 100D thereof in FIG. 5 are similar to the display apparatus 10B and the backlight module 100B thereof in FIG. 3, and the difference between them lies in that the third microstructures 144 of the display apparatus 10B and the backlight module 100B thereof in FIG. 3 may be omitted in the display apparatus 10D and the backlight module 100D thereof in FIG. 5.

In summary of the foregoing, according to an embodiment of the disclosure, the backlight module includes the substrate, the light-emitting elements, the optical element, the first microstructures, and the second microstructures. The light-emitting elements are disposed on the substrate. Each light-emitting element is adapted to provide an illumination light beam. The light-emitting elements are located between the optical element and the substrate. The first microstructures are located between the optical element and the light-emitting elements and respectively shield the light-emitting elements. The optical element is located between the second microstructures and the first microstructures. The area of each first microstructure is greater than the area of each second microstructure.

By shielding the first microstructures of the light-emitting element, the proportion of the illumination light beam emitted by the light-emitting element that directly penetrates out of the backlight module can be reduced. Through the second microstructures, the number of times that the illumination light beam emitted by the light-emitting element is refracted/diffused by the internal structure of the optical element can be increased. Accordingly, the illumination light beam can be uniformly diffused to the first regions above the light-emitting element and the second region between the first regions, achieving blurring of light shades of the backlight module. The display apparatus of the disclosure embodiment applies the backlight module and has good display quality.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A backlight module, comprising:
a substrate;
a plurality of light-emitting elements disposed on the substrate, wherein each of the light-emitting elements is adapted to provide an illumination light beam;
an optical element, wherein the light-emitting elements are located between the optical element and the substrate;
a plurality of first microstructures located between the optical element and the light-emitting elements and respectively shielding the light-emitting elements; and
a plurality of second microstructures, wherein the optical element is located between the second microstructures and the first microstructures, and an area of each of the first microstructures is greater than an area of each of the second microstructures.

2. The backlight module according to claim 1, wherein the optical element comprises a diffuser plate having a light incident surface and a light emitting surface opposite to each other, and the first microstructures and the second microstructures are respectively disposed on the light incident surface and the light emitting surface of the diffuser plate.

3. The backlight module according to claim 2, further comprising:
at least one optical film, wherein the second microstructures are disposed between the at least one optical film and the diffuser plate.

4. The backlight module according to claim 1, wherein the optical element has a light incident surface facing the light-emitting elements, the light incident surface of the optical element is spaced apart from the substrate by a distance, and the distance is less than 5 mm.

5. The backlight module according to claim 1, wherein the optical element comprises at least one first optical film.

6. The backlight module according to claim 5, further comprising:
a lower diffuser plate disposed between the first microstructures and the light-emitting elements; and
an upper diffuser plate, wherein the at least one first optical film is disposed between the upper diffuser plate and the lower diffuser plate.

7. The backlight module according to claim 6, wherein the lower diffuser plate has a light incident surface and a light emitting surface opposite to each other, and the first microstructures are disposed on the light emitting surface of the lower diffuser plate.

8. The backlight module according to claim 6, wherein the upper diffuser plate has a light incident surface and a light emitting surface opposite to each other, and the second microstructures are disposed on the light incident surface of the upper diffuser plate.

9. The backlight module according to claim 6, wherein the lower diffuser plate has a light incident surface facing the light-emitting elements, the light incident surface of the lower diffuser plate is spaced apart from the substrate by a distance, and the distance is less than or equal to 0.3 mm and greater than or equal to 0.2 mm.

10. The backlight module according to claim 5, further comprising:
a plurality of third microstructures disposed between the at least one first optical film and the light-emitting elements and located beside the first microstructures, wherein an area of each of the third microstructures is less than the area of each of the first microstructures.

11. The backlight module according to claim 10, further comprising:
a lower diffuser plate disposed between the first microstructures and the light-emitting elements,
wherein the lower diffuser plate has a light incident surface and a light emitting surface opposite to each other, and the first microstructures and the third microstructures are disposed on the light emitting surface of the lower diffuser plate.

12. The backlight module according to claim 10, wherein the third microstructures are evenly disposed between any two of the first microstructures.

13. The backlight module according to claim 10, wherein a configuration density of the third microstructures gradually decreases from a place close to the first microstructures to a place away from the first microstructures.

14. The backlight module according to claim 5, further comprising:
at least one second optical film, wherein the second microstructures are disposed between the at least one second optical film and the at least one first optical film.

15. The backlight module according to claim 1, wherein a configuration density of the second microstructures is greater than a configuration density of the first microstructures.

16. The backlight module according to claim 1, wherein part of the second microstructures are overlapped with the first microstructures.

17. The backlight module according to claim 1, wherein the second microstructures are evenly distributed.

18. The backlight module according to claim 1, wherein a configuration density of the second microstructures gradually decreases from a place close to the first microstructures to a place away from the first microstructures.

19. A display apparatus, comprising:
a backlight module, comprising:
a substrate;
a plurality of light-emitting elements disposed on the substrate, wherein each of the light-emitting elements is adapted to provide an illumination light beam;
an optical element, wherein the light-emitting elements are located between the optical element and the substrate;
a plurality of first microstructures located between the optical element and the light-emitting elements and respectively shielding the light-emitting elements; and
a plurality of second microstructures, wherein the optical element is located between the second microstructures and the first microstructures, and an area of each of the first microstructures is greater than an area of each of the second microstructures; and
a display panel disposed on the backlight module.
